(19) United States
(12) Patent Application Publication
(10) Pub. No.: US 2026/0250156 A1
(43) Pub. Date: Aug. 27, 2026

(54) PRECURSOR OF CATHODE ACTIVE MATERIAL FOR NONAQUEOUS ELECTROLYTE SECONDARY BATTERY AND METHOD FOR PRODUCING PRECURSOR OF CATHODE ACTIVE MATERIAL FOR NONAQUEOUS ELECTROLYTE SECONDARY BATTERY

(71) Applicant: TANAKA CHEMICAL CORPORATION, Fukui (JP)

(72) Inventors: Hiroaki ISHIDA, Fukui (JP); Yudai YASUNO, Fukui (JP)

(73) Assignee: TANAKA CHEMICAL CORPORATION, Fukui (JP)

(21) Appl. No.: 19/549,625

(22) Filed: Feb. 25, 2026

(30) Foreign Application Priority Data
Feb. 26, 2025 (JP) 2025-029072

(51) Int. Cl. C01G 53/84; H01M 4/525

(52) U.S. Cl. CPC C01G 53/84; H01M 4/525; C01P 2004/50; C01P 2004/61; C01P 2006/11; C01P 2006/12; C01P 2006/40

(57) ABSTRACT

Provided is a precursor of a cathode active material for a nonaqueous electrolyte secondary battery, which includes at least nickel, the precursor including secondary particles formed by aggregating a plurality of primary particles, wherein the secondary particles include a core particle inside the secondary particles, and 1.25≤(b/B)/(a/A) is satisfied, when an average secondary particle diameter of particles P₅₀ corresponding to a particle diameter D50 of the secondary particles at 50% of a cumulative volume percentage is defined as A (μm) and an average core particle diameter of the particles P₅₀ is defined as a (μm), and when an average secondary particle diameter of particles P₉₀ corresponding to a particle diameter D90 of the secondary particles at 90% of a cumulative volume percentage is defined as B (μm) and an average core particle diameter of the particles P₉₀ is defined as b (μm).

### CROSS REFERENCE TO RELATED APPLICATIONS

The present application claims the benefit of foreign priority to Japanese Patent Application No. 2025-029072, filed on Feb. 26, 2025, which is incorporated herein by reference in its entirety.

### BACKGROUND

### Technical Field

The present disclosure relates to a precursor of a cathode active material for a nonaqueous electrolyte secondary battery and a method for producing a precursor of a cathode active material for a nonaqueous electrolyte secondary battery.

### Description of the Related Art

In recent years, from the viewpoint of reducing environmental load, secondary batteries have been used in a wide range of fields, including portable devices such as mobile phones and portable personal computers, as well as vehicles that use or combine electricity as power sources. Examples of the secondary batteries include, for example, nonaqueous electrolyte secondary batteries such as lithium-ion secondary batteries. These nonaqueous electrolyte secondary batteries are suitable for miniaturization and weight reduction, and exhibit various excellent battery characteristics.

Secondary particles formed by aggregating a plurality of primary particles is known to be included in a precursor of a cathode active material for a nonaqueous electrolyte secondary battery. As such secondary particles, core-shell type secondary particles composed of a central part (core particle) formed by aggregating primary particles and a shell part formed by aggregating primary particles have been known. Such core-shell type secondary particles can be produced by a production method including a core generation step and a particle growth step. For example, Japanese Patent Application Laid-Open No. 2019-077577 discloses secondary particles having a two-layer structure, wherein an average ratio of an outer diameter of a central part to a particle diameter falls within a range of 10% to 50%.

### SUMMARY

Cracks may be generated on the surface of the core-shell type secondary particles. When a cathode active material is produced from a precursor containing such secondary particles, battery characteristics of a nonaqueous electrolyte secondary battery may be adversely affected. The present disclosure is related to a precursor of a cathode active material for a nonaqueous electrolyte secondary battery, in which particle cracks of secondary particles are suppressed, and a production method thereof.

The present disclosure relates to, for example, a precursor of a cathode active material for a nonaqueous electrolyte secondary battery, which includes nickel, the precursor including secondary particles formed by aggregating a plurality of primary particles, wherein the secondary particles include a core particle inside the secondary particles, and 1.25≤(b/B)/(a/A) is satisfied, when an average secondary particle diameter of particles P₅₀ corresponding to a particle diameter D50 of the secondary particles at 50% of a cumulative volume percentage is defined as A (μm) and an average core particle diameter of the particles P₅₀ is defined as a (μm), and when an average secondary particle diameter of particles P₉₀ corresponding to a particle diameter D90 of the secondary particles at 90% of a cumulative volume percentage is defined as B (μm) and an average core particle diameter of the particles P₉₀ is defined as b (μm).

The present disclosure also relates to, for example, a method for producing a precursor of a cathode active material for a nonaqueous electrolyte secondary battery, the method including: a core generation step of supplying a metal-containing aqueous solution that contains nickel, a complexing agent, and an alkaline aqueous solution to a reaction vessel to obtain a core particle; and a particle growth step of supplying the metal-containing aqueous solution, the complexing agent, and the alkaline aqueous solution to the reaction vessel including the core particle obtained in the core generation step and water to obtain secondary particles, wherein a slurry is subjected to concentration in the particle growth step, and when a concentration of the slurry at a start of a reaction is S1 (g/L) and a concentration of the slurry at a stop of the reaction is S2 (g/L) in the particle growth step, 0<S1≤100, 100≤S2≤400, and 0<S1/S2≤0.30 are satisfied.

According to an embodiment of the present disclosure, a precursor of a cathode active material for a nonaqueous electrolyte secondary battery, in which particle cracks of secondary particles are suppressed, and its production method can be provided.

### DETAILED DESCRIPTION

The following lists exemplary aspects of the present disclosure.

[1] A precursor of a cathode active material for a nonaqueous electrolyte secondary battery, which includes at least nickel, the precursor including secondary particles formed by aggregating a plurality of primary particles,
wherein the secondary particles include a core particle inside the secondary particles, and
1.25≤(b/B)/(a/A) is satisfied, when an average secondary particle diameter of particles P₅₀ corresponding to a particle diameter D50 of the secondary particles at 50% of a cumulative volume percentage is defined as A (μm) and an average core particle diameter of the particles P₅₀ is defined as a (μm), and when an average secondary particle diameter of particles P₉₀ corresponding to a particle diameter D90 of the secondary particles at 90% of a cumulative volume percentage is defined as B (μm) and an average core particle diameter of the particles P₉₀ is defined as b (μm).

[2] The precursor according to [1], wherein the precursor is a metal complex compound represented by a compositional formula (I) below:

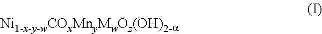

wherein x, y, w, z, and α satisfy 0≤x≤0.5, 0≤y≤0.5, 0≤w≤0.1, 0<x+y+w≤0.5, 0≤z≤3, −0.5≤α≤2, and α−z<2, and M is one or more kinds of addition elements selected from the group consisting of Fe, Cu, Ti, Mg, Al, Zn, Sn, Zr, Nb, Ga, W, Mo, B, and Si.

[3] The precursor according to [1] or [2], wherein (D90-D10)/D50 is 0.7 or less, where:
D10 is a particle diameter of the secondary particles at 10% of the cumulative volume percentage, D50 is the particle diameter D50, and D90 is a particle diameter of the secondary particles at 90% of the cumulative volume percentage.

[4] The precursor according to any one of [1] to [3], wherein (b/B)/(a/A)≤3.00 is satisfied.

[5] A cathode active material for a nonaqueous electrolyte secondary battery, which is a fired product of the precursor according to any one of [1] to [4] and a lithium compound.

[6] A method for producing a precursor of a cathode active material for a nonaqueous electrolyte secondary battery, the method including:
a core generation step of supplying a metal-containing aqueous solution that contains nickel, a complexing agent, and an alkaline aqueous solution to a reaction vessel to obtain a core particle; and
a particle growth step of supplying the metal-containing aqueous solution, the complexing agent, and the alkaline aqueous solution to the reaction vessel including the core particle obtained in the core generation step and water to obtain secondary particles,
wherein a slurry is subjected to concentration in the particle growth step, and
when a concentration of the slurry at a start of a reaction is S1 (g/L) and a concentration of the slurry at a stop of the reaction is S2 (g/L) in the particle growth step, 0<S|≤100, 100≤S2≤400, and 0<S1/S2≤0.30 are satisfied.

[7] The method according to [6], wherein 30≤S1≤100 is satisfied.

[8] The method according to [6] or [7], wherein the slurry obtained immediately before the particle growth step is used instead of the core particle to repeat the particle growth step until the particle diameter D50 at 50% of the cumulative volume percentage reaches 10 μm or more.

### [Precursor of Cathode Active Material]

Hereinafter, a precursor of a cathode active material for a nonaqueous electrolyte secondary battery will be described in detail. The precursor of the present disclosure includes secondary particles formed by aggregating a plurality of primary particles. The particle shape of the precursor of the present disclosure is not particularly limited, and may have a wide variety of shapes. Examples of the shape of the primary particle can include, for example, a needle shape, a plate shape, and a columnar shape. Examples of the shape of the secondary particles can include, for example, a substantially spherical shape and a substantially oval shape.

The precursor according to one embodiment of the present disclosure includes core-shell type secondary particles including a core particle inside the secondary particles. In the precursor, an average secondary particle diameter of particles P₅₀ corresponding to a particle diameter D50 of the secondary particles including a core particle inside the secondary particles at 50% of a cumulative volume percentage is defined as A (μm) and an average core particle diameter of the particles P₅₀ is defined as a (μm). In addition, in the precursor, an average secondary particle diameter of particles P₉₀ corresponding to a particle diameter D90 of the secondary particles including a core particle inside the secondary particles at 90% of a cumulative volume percentage is defined as B (μm) and an average core particle diameter of the particles P₉₀ is defined as b (μm) among the secondary particles. In the precursor according to one embodiment of the present disclosure, A, a, B, and b satisfy the following relational expression.

$$1.25 \leq ( b / B ) / ( a / A )$$

(a/A) is a ratio of an average core particle diameter to an average secondary particle diameter of particles P₅₀ of a size corresponding to D50. (b/B) is a ratio of an average core particle diameter to an average secondary particle diameter of particles P₉₀ of a size corresponding to D90. When (b/B)/(a/A) is equal to 1, it suggests that a ratio of a core particle diameter to a secondary particle diameter is constant regardless of a size of secondary particles. On the other hand, when (b/B)/(a/A) is larger than 1, it is suggested that a ratio of a core particle diameter to a secondary particle diameter of the particles P₉₀ of a size corresponding to D90 is large (in other words, the thickness of the shell part is thin relative to the core particle diameter), or a ratio of a core particle diameter to a secondary particle diameter of the particles P₅₀ of a size corresponding to D50 is small (in other words, the thickness of the shell part is thick relative to the core particle diameter).

The present inventors found that particle cracks of the core-shell type secondary particles are easily generated in particles having a large size. In addition, when the particles having a large size have a difference in a ratio between the thickness of the shell part and the thickness of the core particle, they found that the particle cracks are easily generated due to a difference between the density of the core particle and the density of the shell part. 1.25≤(b/B)/(a/A) is obtained from such a novel finding by the present inventors. When (b/B)/(a/A) falls within an appropriate range, the particle cracks of the core-shell type secondary particles can be suppressed.

(b/B)/(a/A) is 1.25 or more, preferably 1.40 or more, more preferably 1.50 or more, still more preferably 1.60 or more, and particularly preferably 1.70 or more. (b/B)/(a/A) may be 3.00 or less. (b/B)/(a/A) is preferably 2.80 or less, more preferably 2.60 or less, still more preferably 2.40 or less, and particularly preferably 2.20 or less.

The lower limit value and the upper limit value of (b/B)/(a/A) can be optionally combined within the disclosed range. For example, (b/B)/(a/A) is preferably 1.25 or more and 3.00 or less, more preferably 1.40 or more and 2.80 or less, still more preferably 1.50 or more and 2.60 or less, particularly preferably 1.60 or more and 2.40 or less, and most preferably 1.70 or more and 2.20 or less.

The average secondary particle diameter A of the particles P₅₀ is not particularly limited. The average secondary particle diameter A of the particles P₅₀ is preferably 10 μm or more and 30 μm or less, more preferably 12 μm or more and 25 μm or less, and still more preferably 14 μm or more and 20 μm or less.

The average secondary particle diameter B of the particles P₉₀ is not particularly limited. The average secondary particle diameter B of the particles P₉₀ is preferably 15 μm or more and 40 μm or less, more preferably 17 μm or more and 30 μm or less, and still more preferably 18 μm or more and 25 μm or less.

The average core particle diameter a of the particles P₅₀ is not particularly limited.

The average core particle diameter a of the particles P₅₀ is preferably 0.5 μm or more and 10 μm or less, more preferably 1 μm or more and 9 μm or less, still more preferably 2 μm or more and 8 μm or less, and particularly preferably 3 μm or more and 7 μm or less.

The average core particle diameter b of the particles P₉₀ is not particularly limited. The average core particle diameter b of the particles P₉₀ is preferably 1 μm or more and 13 μm or less, more preferably 2 μm or more and 12 μm or less, still more preferably 3 μm or more and 11 μm or less, and particularly preferably 4 μm or more and 10 μm or less.

In the present specification, the average secondary particle diameter A of the particles P₅₀, the average core particle diameter a of the particles P₅₀, the average secondary particle diameter B of the particles P₉₀, and the average core particle diameter b of the particles P₉₀ are measured by the following method. Note that, image processing software “ImageJ” can be used for image analysis.

### (Measurement Method)

In a cross-sectional SEM image at magnification of 3,000× to 10,000×, a secondary particle in which a boundary between the core particle and the shell part can be observed is selected. In the secondary particle, a distance between two points on the periphery of the shell part, where the distance is maximum, is defined as a secondary particle diameter (μm). In the secondary particle, a distance between two points on the periphery of the core particle, where the distance is maximum, is defined as a core particle diameter (μm). Ten secondary particles whose secondary particle diameters reach D50±5% are selected, which are defined as the group of the particles P₅₀. Ten secondary particles whose secondary particle diameters reach D90±5% are selected, which are defined as the group of the particles P₉₀. In the group of the particles P₅₀, secondary particle diameters are averaged in terms of number to obtain an average secondary particle diameter A, and core particle diameters are averaged in terms of number to obtain an average core particle diameter a. In the group of the particles P₉₀, secondary particle diameters are averaged in terms of number to obtain an average secondary particle diameter B, and core particle diameters are averaged in terms of number to obtain an average core particle diameter b.

The precursor of the present disclosure may be a metal complex compound represented by the following compositional formula (I).

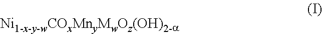

(In the formula, x, y, w, z, and α satisfy 0≤x≤0.5, 0≤y≤0.5, 0≤w≤0.1, 0<x+y+w≤0.5, 0≤z≤3, −0.5≤α≤2, and α−z<2, and M is one or more kinds of addition elements selected from the group consisting of Fe, Cu, Ti, Mg, Al, Zn, Sn, Zr, Nb, Ga, W, Mo, B, and Si.)

In the compositional formula (I), x preferably satisfies 0.01≤x≤0.4, more preferably satisfies 0.015≤x≤0.2, still more preferably satisfies 0.02≤x≤0.1, and particularly preferably satisfies 0.025≤x≤0.07.

In the compositional formula (I), y preferably satisfies 0.01≤y≤0.4, more preferably satisfies 0.03≤y≤0.3, still more preferably satisfies 0.04≤y≤0.2, and particularly preferably satisfies 0.05≤y≤0.15.

In the compositional formula (I), w preferably satisfies 0≤w≤0.05, more preferably satisfies 0≤w≤0.04, still more preferably satisfies 0≤w≤0.03, and particularly preferably satisfies 0≤w≤0.02.

In the compositional formula (I), x+y+w is preferably 0.01≤x+y+w≤0.4, more preferably 0.02≤x+y+w≤0.3, and still more preferably 0.03≤x+y+w≤0.2.

In the precursor of the present disclosure, the particle diameter D50 of the secondary particles at 50% of the cumulative volume percentage is not particularly limited. The D50 of the secondary particles affects the packing density of the cathode active material into a cathode and the contact property with an electrolyte. The D50 of the secondary particles in the precursor of the present disclosure may be 10 μm or more, may be 12 μm or more, or may be 14 μm or more. The D50 of the secondary particles in the precursor of the present disclosure may be 30 μm or less, may be 25 μm or less, or may be 20 μm or less. The lower limit value and the upper limit value of the D50 of the secondary particles in the precursor of the present disclosure can be optionally combined within the disclosed ranges. For example, the D50 of the secondary particles in the precursor of the present disclosure may be 10 μm or more and 30 μm or less, may be 12 μm or more and 25 μm or less, or may be 14 μm or more and 20 μm or less. Note that the D50 is measured by a particle size distribution measurement apparatus using a laser diffraction·scattering method.

In the precursor of the present disclosure, from the viewpoint of battery characteristics, (D90-D10)/D50 is preferably 0.7 or less, more preferably 0.60 or less, and still more preferably 0.50 or less, where: D10 is a particle diameter of the secondary particles at 10% of the cumulative volume percentage, D50 is a particle diameter of the secondary particles at 50% of the cumulative volume percentage, and D90 is a particle diameter of the secondary particles at 90% of the cumulative volume percentage. In addition, for example, (D90-D10)/D50 is preferably 0.05 or more, more preferably 0.10 or more, and still more preferably 0.15 or more. The upper limit value and the lower limit value of the (D90-D10)/D50 can be optionally combined within the disclosed ranges. For example, the (D90-D10)/D50 is preferably 0.05 or more and 0.70 or less, more preferably 0.10 or more and 0.60 or less, and still more preferably 0.15 or more and 0.50 or less. Note that the D10 and the D90 are measured by a particle size distribution measurement apparatus using a laser diffraction·scattering method in the similar manner as in the D50.

The BET specific surface area of the precursor of the present disclosure is not particularly limited. For example, the BET specific surface area of the precursor of the present disclosure is preferably 5.0 m²/g or more, more preferably 7.0 m²/g or more, and still more preferably 9.0 m²/g or more, from the viewpoint of improving a contact area with a non-aqueous electrolyte. The BET specific surface area of the precursor of the present disclosure is preferably 30.0 m²/g or less, more preferably 28.0 m²/g or less, and still more preferably 26.0 m²/g or less, from the viewpoint of improving crush strength of the cathode active material. The lower limit value and the upper limit value of the BET specific surface area can be optionally combined within the disclosed range. For example, the BET specific surface area of the precursor of the present disclosure is preferably 5.0 m²/g or more and 30.0 m²/g or less, more preferably 7.0 m²/g or more and 28.0 m²/g or less, and still more preferably 9.0 m²/g or more and 26.0 m²/g or less.

The tap density (TD) of the precursor of the present disclosure is not particularly limited. For example, the tap density (TD) of the precursor of the present disclosure is preferably 1.2 g/mL or more, and more preferably 1.4 g/mL or more, from the viewpoint of improving the packing density of the cathode active material into a cathode. In addition, the tap density (TD) of the precursor of the present disclosure may be 2.4 g/mL or less, or may be 2.2 g/mL or less, from the viewpoint of improving, for example, the contact property between a cathode active material and a non-aqueous electrolyte. The lower limit value and the upper limit value of the tap density (TD) can be optionally combined within the disclosed range. For example, the tap density (TD) of the precursor of the present disclosure is preferably 1.2 g/mL or more and 2.4 g/mL or less, and more preferably 1.4 g/mL or more and 2.2 g/mL or less.

### [Production Method of Precursor]

Next, the production method of the precursor of the present disclosure will be described. The precursor of the present disclosure can be produced by the following method including, for example, a core generation step and a particle growth step.

### (Core Generation Step)

In the core generation step, a metal-containing aqueous solution that contains nickel, a complexing agent, and an alkaline aqueous solution are supplied to a reaction vessel, to obtain a core particle. Specifically, water, a complexing agent, and an alkaline aqueous solution are supplied to a reaction vessel to prepare a base liquid. Then, a metal-containing aqueous solution that contains nickel, a complexing agent, and an alkaline aqueous solution are supplied to the reaction vessel and undergo the crystallization reaction, to obtain a core particle.

Specifically, by a co-precipitation method, a metal salt solution that contains a nickel salt (for example, a sulphate), and, as optional components, a cobalt salt (for example, a sulphate), a manganese salt (for example, a sulphate), and a salt of an addition element M (for example, a sulphate) (hereinafter, may be simply referred to as “metal-containing aqueous solution”), an alkaline aqueous solution, and a complexing agent are appropriately added to a reaction vessel, and are crystallized through neutralization reaction in the reaction vessel, to obtain a slurry suspension that contains a nickel-containing hydroxide. As a solvent of the suspension, for example, water is used.

The complexing agent is not particularly limited as long as it can form a complex with nickel, and, as optional components, cobalt, manganese, and an addition element M in an aqueous solution. Examples of the complexing agent include, for example, ammonium ion donors (ammonium sulfate, ammonium chloride, ammonium carbonate, ammonium fluoride, and the like), hydrazine, ethylenediaminetetraacetic acid, nitrilotriacetic acid, uracil diacetic acid, and glycine.

The alkaline aqueous solution is not particularly limited as long as the pH value of the aqueous solution is adjusted in co-precipitation. Examples of the alkaline aqueous solution include aqueous solutions of alkali metal hydroxides (for example, sodium hydroxide and potassium hydroxide).

When the metal-containing aqueous solution, the complexing agent, and the alkaline aqueous solution described above are supplied into the reaction vessel, nickel, and, as optional components, cobalt, manganese, and the addition element M undergo the crystallization reaction, to produce the core particle. In the core generation step, while the temperature in the reaction vessel is controlled within a range of, for example, 30° C. to 80° C. and preferably 40° C. to 70° C. and the pH value in the reaction vessel is controlled within a range of, for example, pH 10 to pH 13 and preferably pH 10.5 to pH 12.5 based on the solution temperature of 40° C., the substances in the reaction vessel are appropriately stirred.

### (Particle Growth Step)

In the particle growth step, a metal-containing aqueous solution, a complexing agent, and an alkaline aqueous solution are supplied to the reaction vessel containing the core particle obtained in the core generation step, the water, the complexing agent, and the alkaline aqueous solution, to obtain secondary particles. Specifically, the core particle obtained in the core generation step, the complexing agent, and the alkaline aqueous solution are supplied to a reaction vessel, to prepare a base liquid. Then, a metal-containing aqueous solution that contains nickel, a complexing agent, and an alkaline aqueous solution are supplied to the reaction vessel and undergo the crystallization reaction, to grow particles. The metal-containing aqueous solution, the complexing agent, and the alkaline aqueous solution used in the core generation step can be similarly used. Moreover, the particles prepared in the particle growth step as the core particle may be subjected to the particle growth step again.

In the particle growth step, while the temperature in the reaction vessel is controlled within a range of, for example, 30° C. to 80° C. and preferably 40° C. to 70° C. and the pH value in the reaction vessel is controlled within a range of, for example, pH 10 to pH 13 and preferably pH 10.5 to pH 12.5 based on the solution temperature of 40° C., the substances in the reaction vessel are appropriately stirred.

In the particle growth step, concentration of a slurry is performed. As described below, by controlling the conditions of the concentration of the slurry, a precursor satisfying 1.25≤(b/B)/(a/A) can be produced.

In the particle growth step, a portion of the slurry containing the nickel-containing hydroxide can be allowed to overflow from the reaction vessel to be extracted. The extracted slurry is concentrated in a concentration vessel, to increase the concentration of the nickel-containing hydroxide in the slurry. The concentration may be performed by an optional solid liquid separation method (for example, filtration, precipitation, extraction, and the like). The concentrated slurry is returned to the reaction vessel. Therefore, in the reaction vessel, while an unreacted metal-containing aqueous solution and the returned slurry are supplied together, the reaction is performed. The slurry concentration (the concentration of the nickel-containing hydroxide) in the reaction vessel increases over time as the reaction proceeds.

In the particle growth step, when a concentration of the slurry at the start of the reaction is S1 (g/L) and a concentration of the slurry at the stop of the reaction is S2 (g/L), 0<S1≤100, 100≤S2≤400, and 0<S1/S2≤0.30 are set to be satisfied. When the range of S1 satisfies 0<S1≤100, there exists a core particle required for particle growth, and thus particle growth can be uniformly performed. In addition, S1 preferably satisfies 30≤S1≤100, more preferably satisfies 40≤S1≤90, and particularly preferably satisfies 50≤S1≤80. When the range of S2 satisfies 100≤S2≤400, sufficiently grown particles are easily obtained, and particle growth can be further uniformly performed. In addition, S2 preferably satisfies 150≤S2≤350, and more preferably satisfies 180≤S2≤320. S1/S2 preferably satisfies 0.10≤S1/S2≤0.29, and more preferably satisfies 0.15≤S1/S2≤0.28.

In the particle growth step, the contents mentioned above may be repeated multiple times. That is, a plurality of batches may be performed by supplying a part of the slurry obtained in the previous batch instead of the core particle to the next batch so that S1 and S2 satisfy the above condition in each batch. Particularly, the particle growth step is preferably repeated until the particle diameter D50 of the secondary particles reaches 10 μm or more, preferably 12 μm or more, and more preferably 14 μm or more.

After the slurry containing the nickel-containing hydroxide obtained as described above is filtrated, the nickel-containing hydroxide is washed with an alkaline aqueous solution, it is separated into the solid phase and the liquid phase by the solid liquid separation, and the solid phase that contains the nickel-containing hydroxide can be obtained. If necessary, the solid phase that contains the nickel-containing hydroxide may be dried to obtain a nickel-containing hydroxide powder. If necessary, before the solid phase is dried, the solid phase may be washed with water or the like. The precursor of the present disclosure may be the nickel-containing hydroxide obtained in the above manner, or may be a nickel-containing oxide obtained by further oxidizing the nickel-containing hydroxide obtained in the above manner. Examples of the method for preparing the nickel-containing oxide from the nickel-containing hydroxide can include, for example, an oxidization treatment of performing firing under an atmosphere in which oxygen gas exists at a temperature of 300° C. or more and 800° C. or less for 1 hour or more and 10 hours or less.

### [Cathode Active Material]

Next, a cathode active material for a nonaqueous electrolyte secondary battery (hereinafter, may be simply referred to as “the cathode active material of the present disclosure”), which is a fired product of the precursor of the present disclosure and a lithium compound, will be described. The cathode active material of the present disclosure is an aspect in which the precursor of the present disclosure is fired with the lithium compound. The precursor of the present disclosure can be fired with the lithium compound to obtain a nonaqueous electrolyte secondary battery having excellent battery characteristics.

The crystalline structure of the cathode active material of the present disclosure is a layered structure, and is preferably a trigonal crystalline structure, a hexagonal crystalline structure, or a monoclinic crystalline structure from the viewpoint of obtaining a secondary battery having a high discharge capacity. The cathode active material of the present disclosure can be used, for example, as a cathode active material for a nonaqueous electrolyte secondary battery such as a lithium-ion secondary battery.

Next, a method for producing the cathode active material of the present disclosure will be described. For example, in the method for producing the cathode active material of the present disclosure, first, a lithium compound is added to the precursor of the present disclosure to prepare a mixture of the precursor of the present disclosure and the lithium compound. The lithium compound is not particularly limited as long as it is a compound including lithium, and examples of the lithium compound can include, for example, lithium carbonate and lithium hydroxide.

When the mixture is prepared, the lithium compound and the precursor of the present disclosure may be mixed so that, for example, a molar ratio of lithium of the lithium compound to the total amount of the contained metals (the total amount of nickel, and, as optional components, cobalt, manganese, and the addition element M) of the precursor of the present disclosure falls within a range of 1.00 or more and 1.10 or less.

Next, the above-described mixture can be fired to produce a cathode active material. Examples of the firing condition include, for example, a firing temperature of 600° C. or more and 1000° C. or less, a rate of temperature increase of 50° C./h or more and 300° C./h or less, and a firing time of 5 hours or more and 20 hours or less. The firing may be performed, for example, under an air atmosphere or under an oxygen atmosphere. In addition, a firing furnace used for firing is not particularly limited, and examples of the firing furnace include a static box furnace and a continuous furnace of roller hearth type.

### [Nonaqueous Electrolyte Secondary Battery]

A cathode using the cathode active material of the present disclosure, an anode, an electrolytic solution containing a predetermined electrolyte, and a separator can be prepared by a known method to assemble a nonaqueous electrolyte secondary battery.

The cathode includes a cathode current collector, and a cathode active material layer using the cathode active material of the present disclosure formed on a surface of the cathode current collector. The cathode active material layer has the cathode active material of the present disclosure, a binding agent (binder), and, if necessary, a conductive additive. The conductive additive is not particularly limited as long as it can be used for the nonaqueous electrolyte secondary battery, and, for example, carbon-based materials can be used. Examples of the carbon-based materials can include graphite powder, carbon black (for example, acetylene black), and fibrous carbon materials. The binding agent is not particularly limited, and, for example, thermoplastic resins can be used. Examples of the thermoplastic resin can include polyvinylidene fluoride (PVdF), butadiene rubber (BR), polyvinyl alcohol (PVA), carboxymethyl cellulose (CMC), polytetrafluoroethylene (PTFE), and combinations thereof. The cathode current collector is not particularly limited, but examples of the cathode current collector can include, for example, electrically conductive metal materials such as aluminum foil, nickel foil, and stainless steel.

The cathode is obtained by mixing, for example, a cathode active material, a conductive additive, and a binding agent to prepare a cathode active material slurry, filling a cathode current collector with the cathode active material slurry by a known filling method, and drying the slurry, followed by rolling and fixing with a press or the like.

Examples of the anode can include an electrode in which an anode active material layer including an anode active material is supported on an anode current collector, and an electrode consisting of an anode active material alone. The anode active material is not particularly limited as long as it is usually used, and, for example, graphite such as natural graphite and artificial graphite, cokes, carbon black, pyrolytic carbons, carbon fibers, and fired bodies of organic polymer compounds can be used. The anode current collector is not particularly limited, and examples of the anode current collector can include, for example, metal materials such as copper foil, nickel foil, and stainless steel. The anode may be metal lithium.

To the anode active material layer, a conductive additive, a binder, and the like may be further added if necessary. Examples of the conductive additive and the binder include the same as those used in the above-described cathode active material layer.

The anode is obtained by mixing, for example, an anode active material, and if necessary, a conductive additive, a binding agent, and water to prepare an anode active material slurry, filling an anode current collector with the anode active material slurry by a known filling method, and drying the slurry, followed by rolling and fixing with a press or the like.

Examples of the electrolyte contained in the nonaqueous electrolyte include LiClO₄, LiPF₆, LiAsF₆, LiSbF₆, LiBF₄, LiCF₃SO₃, LiN(SO₂CF₃)₂, LiN(SO₂C₂F₅)₂, LiN(SO₂CF₃)(COCF₃), Li(C₄F₉SO₃), LiC(SO₂CF₃)₃, Li₂B₁₀Cl₁₀, LiBOB (where, BOB is bis(oxalato)borate), LiFSI (where, FSI is bis(fluorosulfonyl)imide), lithium salts of lower aliphatic carboxylic acid, lithium salts of LiAlCl₄ and the like. These may be used alone or may be used in combination of two or more kinds.

As a dispersion medium of the electrolyte, for example, carbonates such as propylene carbonate, ethylene carbonate, dimethyl carbonate, diethyl carbonate, ethyl methyl carbonate, 4-trifluoromethyl-1,3-dioxolan-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, 1,3-propanesultone, or those obtained by further introducing fluoro groups into these organic solvents (those in which one or more hydrogen atoms included in the organic solvents are substituted with fluorine atoms) can be used. These may be used alone or may be used in combination of two or more kinds.

In addition, in place of the electrolyte-containing electrolytic solution, a solid electrolyte may be used. As the solid electrolyte, for example, organic polymer electrolytes such as polyethylene oxide-based polymer compounds, or polymer compounds containing at least one or more kinds of polyorganosiloxane chains or polyoxyalkylene chains may be used. A so-called gel-type electrolyte, in which a nonaqueous electrolytic solution is held in a polymer compound, may also be used. Moreover, examples of the solid electrolyte include inorganic solid electrolytes containing sulfides such as Li₂S—SiS₂, Li₂S—GeS₂, Li₂S—P₂S₅, Li₂S—B₂S₃, Li₂S—SiS₂—Li₃PO₄, Li₂S—SiS₂—Li₂SO₄, and Li₂S—GeS₂—P₂S₅. These may be used alone or may be used in combination of two or more kinds.

The separator is not particularly limited, but for example, materials in the forms of porous membranes, nonwoven fabrics, woven fabrics, and the like, which are formed of polyolefin resins such as polyethylene and polypropylene, fluororesin, nitrogen-containing aromatic polymers can be used. These may be used alone or may be used in combination of two or more kinds.

### EXAMPLES

Next, the present disclosure will be described in more detail by way of Examples and the like, but the present disclosure is not limited to these Examples and the like.

### [Production of Precursor]

### Example 1

### Core Generation Step

After water was added to a reaction vessel equipped with a stirring device of rotary type having a stirring blade and an overflow pipe, an ammonium sulfate aqueous solution as a complexing agent, and a sodium hydroxide aqueous solution were added, to prepare a base liquid. Then, the temperature in the reaction vessel was raised to 70° C.

A nickel sulfate aqueous solution, a cobalt sulfate aqueous solution, and a manganese sulfate aqueous solution were mixed so that a molar ratio of nickel:cobalt:manganese was 85:5:10, to prepare a metal-containing aqueous solution that contained nickel.

Thereafter, the above-described metal-containing aqueous solution, an ammonium sulfate aqueous solution as a complexing agent, and a sodium hydroxide aqueous solution were continuously added into the reaction vessel under stirring, to obtain a slurry that contained nickel-containing hydroxide particles. At this time, while the above-described temperature in the reaction vessel was maintained and the pH in the reaction vessel was maintained at 11.5 based on the solution temperature of 40° C., the solutions were continuously stirred with a stirring machine.

### Particle Growth Step

After water was added to a reaction vessel equipped with a stirring device of rotary type having a stirring blade and an overflow pipe, an ammonium sulfate aqueous solution as a complexing agent, and a sodium hydroxide aqueous solution were added, to prepare a base liquid. A part of the slurry after the stop of the core generation step was supplied, and the temperature in the reaction vessel was raised to 70° C.

Next, the metal-containing aqueous solution, an ammonium sulfate aqueous solution as a complexing agent, and a sodium hydroxide aqueous solution were continuously added to the reaction vessel under stirring, to perform the particle growth step. At this time, while the above-described temperature in the reaction vessel was maintained and the pH in the reaction vessel was maintained at 10.5 based on the solution temperature of 40° C., the solutions were continuously stirred with a stirring machine. The generated slurry that contained nickel-containing hydroxide particles was allowed to overflow from the overflow pipe of the reaction vessel and was introduced into a concentration vessel. In the concentration vessel, the nickel-containing hydroxide particles were subjected to solid liquid separation, a supernatant was discharged to thereby concentrate the slurry, and the concentrated slurry was returned into the reaction vessel. After the stop of the reaction, the slurry was extracted from the reaction vessel using a pump or the like, to extract the slurry that contained nickel-containing hydroxide particles to the outside of the system. The above-described operation in the particle growth step was defined as one batch, and the similar operations were repeated to perform three batches in total (note that, in the second batch and thereafter, the above phrase “a part of the slurry after the stop of the core generation step was supplied” shall be read as “a part of the slurry after the stop of the previous batch was supplied”). In all the batches, the concentration S1 of the slurry at the start of the reaction and the concentration S2 of the slurry at the stop of the reaction satisfied 0<S1≤100, 100≤S2≤400, and 0<S1/S2≤0.30. In the final batch, the concentration S1 of the slurry at the start of the reaction was 71 g/L, and the concentration S2 of the slurry at the stop of the reaction was 266 g/L.

After the extracted metal complex compound-containing slurry was subjected to solid liquid separation and the solid phase was washed with an alkaline aqueous solution, the solid phase was dried, to obtain a nickel-containing hydroxide of Example 1 (precursor of the cathode active material).

### Example 2

### Core Generation Step

The core generation step was performed in the similar manner as in Example 1 except that the pH in the reaction vessel was maintained at 11.4 based on the solution temperature of 40° C.

### Particle Growth Step

After water was added to a reaction vessel equipped with a stirring device of rotary type having a stirring blade and an overflow pipe, an ammonium sulfate aqueous solution as a complexing agent, and a sodium hydroxide aqueous solution were added, to prepare a base liquid. A part of the slurry after the stop of the core generation step was supplied, and the temperature in the reaction vessel was raised to 70° C.

Thereafter, the above-described metal-containing aqueous solution, an ammonium sulfate aqueous solution as a complexing agent, and a sodium hydroxide aqueous solution were continuously added into the reaction vessel under stirring, to perform the particle growth step. At this time, while the above-described temperature in the reaction vessel was maintained and the pH in the reaction vessel was maintained at 10.5 based on the solution temperature of 40° C., the solutions were continuously stirred with a stirring machine. The generated slurry that contained nickel-containing hydroxide particles was allowed to overflow from the overflow pipe of the reaction vessel and was introduced into a concentration vessel. In the concentration vessel, the nickel-containing hydroxide particles were subjected to solid liquid separation, a supernatant was discharged to thereby concentrate the slurry, and the concentrated slurry was returned into the reaction vessel. After the stop of the reaction, the slurry was extracted from the reaction vessel using a pump or the like, to extract the slurry that contained nickel-containing hydroxide particles to the outside of the system. The above-described operation in the particle growth step was defined as one batch, and the similar operations were repeated to perform two batches in total (note that, in the second batch, the above phrase “a part of the slurry after the stop of the core generation step was supplied” shall be read as “a part of the slurry after the stop of the previous batch was supplied”). In all the batches, the concentration S1 of the slurry at the start of the reaction and the concentration S2 of the slurry at the stop of the reaction satisfied 0<S1≤100, 100≤S2≤400, and 0<S1/S2≤0.30. In the final batch, the concentration S1 of the slurry at the start of the reaction was 71 g/L, and the concentration S2 of the slurry at the stop of the reaction was 311 g/L. The subsequent step was performed in the similar manner as in Example 1, to obtain a nickel-containing hydroxide (a precursor of a cathode active material) of Example 2.

### Comparative Example 1

### Core Generation Step

The core generation step was performed in the similar manner as in Example 1 except that the pH in the reaction vessel was maintained at 11.2 based on the solution temperature of 40° C.

### Particle Growth Step

After water was added to a reaction vessel equipped with a stirring device of rotary type having a stirring blade and an overflow pipe, an ammonium sulfate aqueous solution as a complexing agent, and a sodium hydroxide aqueous solution were added, to prepare a base liquid. A part of the slurry after the stop of the core generation step was supplied, and the temperature in the reaction vessel was raised to 70° C.

Thereafter, the above-described metal-containing aqueous solution, an ammonium sulfate aqueous solution as a complexing agent, and a sodium hydroxide aqueous solution were continuously added into the reaction vessel under stirring, to perform the particle growth step. At this time, while the above-described temperature in the reaction vessel was maintained and the pH in the reaction vessel was maintained at 10.5 based on the solution temperature of 40° C., the solutions were continuously stirred with a stirring machine. The generated slurry that contained nickel-containing hydroxide particles was allowed to overflow from the overflow pipe of the reaction vessel and was introduced into a concentration vessel. In the concentration vessel, the nickel-containing hydroxide particles were subjected to solid-liquid separation, a supernatant was discharged to thereby concentrate the slurry, and the concentrated slurry was returned into the reaction vessel. After the stop of the reaction, the slurry was extracted from the reaction vessel using a pump or the like, to extract the slurry that contained nickel-containing hydroxide particles to the outside of the system. The concentration S1 of the slurry at the start of the reaction was 71 g/L, and the concentration S2 of the slurry at the stop of the reaction was 161 g/L. The subsequent step was performed in the similar manner as in Example 1, to obtain a nickel-containing hydroxide (a precursor of a cathode active material) of Comparative Example 1.

The precursors of Examples and Comparative Example were evaluated as described below.

### (1) Compositional Analysis of Nickel-Containing Hydroxide

After the obtained nickel-containing hydroxide was dissolved in hydrochloric acid, the compositional analysis was performed using an inductively coupled plasma emission analysis device (Optima 8300 available from PerkinElmer Japan G.K.).

### (2) D10, D50, D90

The D10, D50, and D90 were measured using a particle size distribution measurement device (MT3300EXII available from MicrotracBEL Corp.) (the principle was the laser diffraction·scattering method). As the measurement conditions, water was used as a solvent, 1 mL of sodium hexametaphosphate as a dispersing agent was charged, the transmittance after the sample was charged was within a range of 80±2%, and no ultrasonic wave was generated. Moreover, as the solvent refractive index at the time of analysis, the refractive index of water of 1.333 was used. In the obtained cumulative particle size distribution curve, a value of the particle diameter at 10% of the cumulative volume percentage from the small particle side was defined as D10 (μm), a value of the particle diameter at 50% of the cumulative volume percentage from the small particle side was defined as D50 (μm), and a value of the particle diameter at 90% of the cumulative volume percentage from the small particle side was defined as D90 (μm).

(3) Average Secondary Particle Diameter a of Particles P₅₀, Average Core Particle Diameter a of Particles P₅₀, Average Secondary Particle Diameter B of Particles P₉₀, and Average Core Particle Diameter b of Particles P₉₀

Each of the nickel-containing hydroxide particles of Examples and Comparative Examples was subjected to cross-sectional SEM observation at magnification of 3,000× to 10,000× to obtain a cross-sectional SEM image of the secondary particle. In the cross-sectional SEM image, a secondary particle in which a boundary between the core particle and the shell part can be observed was selected. In the secondary particle, a distance between two points on the periphery of the shell part, where the distance was maximum, was defined as a secondary particle diameter (μm). In the secondary particle, a distance between two points on the periphery of the core particle, where the distance was maximum, was defined as a core particle diameter (μm). Ten secondary particles whose secondary particle diameters reached D50±5% were selected, which were defined as the group of the particles P₅₀. Ten secondary particles whose secondary particle diameters reached D90±5% were selected, which were defined as the group of the particles P₉₀. In the group of the particles P₅₀, secondary particle diameters were averaged in terms of number to obtain an average secondary particle diameter A, and core particle diameters were averaged in terms of number to obtain an average core particle diameter a. In the group of the particles P₉₀, secondary particle diameters were averaged in terms of number to obtain an average secondary particle diameter B, and core particle diameters were averaged in terms of number to obtain an average core particle diameter b. Image processing software “ImageJ” was used for image analysis.

### (4) Particle Cracks of Secondary Particles

Three fields of view in the SEM image at magnification of 500× were optionally selected, and the number of particles and the equivalent circle diameter of each particle were evaluated using image analysis software (SEM SUPPORTER, available from SYSTEM IN FRONTIER INC.). From the three fields of view in the SEM image in which the number of particles had been counted, the number of secondary particles whose particles were cracked was counted. Note that, the counting of the secondary particles whose particles were cracked was performed in the following manner. First, secondary particles, in which particle cracks had been visually confirmed from the SEM image, were selected. Next, image processing software “ImageJ” was used to measure the length of cracks. Secondary particles, in which cracks having a length of more than 5% of the equivalent circle diameter were generated, were counted as secondary particles having particle cracks. From the number of particles and the number of secondary particles having particle cracks, the percentage (%) of the secondary particles having particle cracks was determined.

### (5) BET Specific Surface Area

1 g of the nickel-containing hydroxide was dried at 105° C. for 30 minutes in a nitrogen atmosphere, and was measured by one point method for BET method using a specific surface area measurement machine (Macsorb, available from Mountech Co., Ltd.).

(6) Tap Density (g/mL)

A tap denser (KYT-4000, available from SEISHIN Enterprise Co., Ltd.) was used to perform measurement by the constant mass measurement method as in the methods described in AS R1628.

The above evaluation results are shown in Table 1. Note that, in Examples in which a plurality of batches was performed, S1 and S2 in the table are the values in the final batch.

TABLE 1

| | | | Comparative |
|---|---|---|---|
| | Example 1 | Example 2 | Example 1 |
| Concentration S1 of slurry | 71 | 71 | 71 |
| at start of reaction [g/L] | | | |
| Concentration S2 of slurry | 266 | 311 | 161 |
| at stop of reaction [g/L] | | | |
| S1/S2 | 0.27 | 0.23 | 0.44 |
| A [μm] | 17.0 | 15.9 | 15.7 |
| B [μm] | 21.3 | 20.8 | 21.9 |
| a [μm] | 3.3 | 4.3 | 10.7 |
| b [μm] | 6.7 | 10.0 | 17.1 |
| (b/B)/(a/A) | 1.62 | 1.78 | 1.15 |
| BET specific surface area [m²/g] | 19.3 | 18.7 | 16.3 |
| Tap density [g/ml] | 1.82 | 1.90 | 1.90 |
| D10 of secondary particles [μm] | 12.2 | 12.7 | 13.7 |
| D50 of secondary particles [μm] | 16.9 | 16.2 | 16.3 |
| D90 of secondary particles [μm] | 21.6 | 21.3 | 22.5 |
| (D90-D10)/D50 | 0.56 | 0.53 | 0.54 |
| Percentage of particle cracks | 0.0% | 3.0% | 25.0% |

In Examples 1 and 2, the particle growth step was performed so that 0<S1≤100, 100≤S2≤400, and 0<S1/S2≤0.30 were satisfied, to produce a precursor. In Comparative Example 1, 0<S1/S2≤0.30 was not satisfied in the particle growth step. The precursors obtained in Examples 1 and 2 exhibited (b/B)/(a/A) of 1.25 or more, while the precursor obtained in Comparative Example 1 exhibited (b/B)/(a/A) of less than 1.25. As shown in Table 1, the precursors obtained in Examples 1 and 2 had secondary particles in which particle cracks were significantly suppressed, compared with the precursor obtained in Comparative Example 1.

The secondary battery that includes the precursor and the cathode active material of the present disclosure is suitably applicable in a wide range of fields, including portable devices and vehicles.

What is claimed is:

1. A precursor of a cathode active material for a nonaqueous electrolyte secondary battery, which includes at least nickel, the precursor comprising secondary particles formed by aggregating a plurality of primary particles,
wherein the secondary particles include a core particle inside the secondary particles, and
1.25≤(b/B)/(a/A) is satisfied, when an average secondary particle diameter of particles P₅₀ corresponding to a particle diameter D50 of the secondary particles at 50% of a cumulative volume percentage is defined as A (μm) and an average core particle diameter of the particles P₅₀ is defined as a (μm), and when an average secondary particle diameter of particles P₉₀ corresponding to a particle diameter D90 of the secondary particles at 90% of a cumulative volume percentage is defined as B (μm) and an average core particle diameter of the particles P₉₀ is defined as b (μm).

2. The precursor according to claim 1, wherein the precursor is a metal complex compound represented by a compositional formula (I) below: 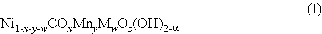
wherein x, y, w, z, and α satisfy 0≤x≤0.5, 0≤y≤0.5, 0≤w≤0.1, 0≤x+y+w≤0.5, 0≤z≤3, −0.5≤α≤2, and α−z<2, and M is one or more kinds of addition elements selected from the group consisting of Fe, Cu, Ti, Mg, Al, Zn, Sn, Zr, Nb, Ga, W, Mo, B, and Si.

3. The precursor according to claim 1, wherein (D90−D10)/D50 is 0.7 or less, where:
D10 is a particle diameter of the secondary particles at 10% of the cumulative volume percentage, D50 is the particle diameter D50, and D90 is a particle diameter of the secondary particles at 90% of the cumulative volume percentage.

4. The precursor according to claim 1, wherein (b/B)/(a/A)≤3.00 is satisfied.

5. A cathode active material for a nonaqueous electrolyte secondary battery, which is a fired product of the precursor according to claim 1 and a lithium compound.
